(19) United States
(12) Patent Application Publication
(10) Pub. No.: US 2012/0044240 A1
(43) Pub. Date: Feb. 23, 2012

(54) ORGANIC LIGHT EMITTING DISPLAY AND METHOD OF DRIVING THE SAME

(76) Inventors: Kyung-Hoon Chung, Yongin-city (KR); Keum-Nam Kim, Yongin-city (KR)

(21) Appl. No.: 13/153,269

(22) Filed: Jun. 3, 2011

(30) Foreign Application Priority Data
Aug. 19, 2010 (KR) 10-2010-0080274

(51) Int. Cl. G09G 3/32; G06F 3/038

(52) U.S. Cl. 345/213; 345/211; 345/76

(57) ABSTRACT

There is provided a method of driving an organic light emitting display capable of minimizing or reducing the amount of instantaneously current flowing in the display that is driven in a concurrent emission method. The method includes setting pixels included in j blocks of a panel in a non-emission state, charging the pixels with voltages corresponding to data signals, and emitting light by the pixels in units of horizontal lines respectively included in the j blocks to correspond to the charged voltages.

### CROSS-REFERENCE TO RELATED APPLICATION

This application claims priority to and the benefit of Korean Patent Application No. 10-2010-0080274, filed on Aug. 19, 2010, in the Korean Intellectual Property Office, the entire content of which is incorporated herein by reference.

### BACKGROUND

1. Field

Aspects of the present invention relate to an organic light emitting display and a method of driving the same.

2. Description of Related Art

Recently, various flat panel displays (FPDs) with reduced weight and volume in comparison to cathode ray tubes (CRTs) have been developed. The FPDs include liquid crystal displays (LCDs), field emission displays (FEDs), plasma display panels (PDPs), and organic light emitting displays.

Among the FPDs, the organic light emitting displays display images using organic light emitting diodes (OLEDs) that generate light by re-combination of electrons and holes. The organic light emitting display has fast response speed and is driven with low power consumption.

In general, the organic light emitting display is categorized as a passive matrix type OLED (PMOLED) display and an active matrix type OLED (AMOLED) display according to a method of driving the OLEDs.

The AMOLED display includes a plurality of scan lines, a plurality of data lines, a plurality of power source lines, and a plurality of pixels coupled to the above lines to be arranged in the form of a matrix. In addition, each of the pixels includes an OLED, a driving transistor for controlling the amount of current supplied to the OLED, a switching transistor for transmitting a data signal to the driving transistor, and a storage capacitor for maintaining the voltage of the data signal.

A method of driving the organic light emitting display is divided into a progressive emission method and a concurrent (e.g., simultaneous) emission method. In the progressive emission method, data are sequentially input to the scan lines, and the pixels are sequentially emitted in units of horizontal lines in the same order as the order of inputting the data.

In the concurrent emission method, after the data are sequentially input to the scan lines and the data are input to all of the pixels, the pixels are concurrently (e.g., simultaneously) emitted. The concurrent emission method has advantages in that the threshold voltage of the driving transistor is compensated for, in that a pixel may have a simple structure, and in that 3D display may be easily realized. However, in the concurrent emission method, since all of the pixels included in a panel are concurrently (e.g., simultaneously) emitted, very large current flows instantaneously.

### SUMMARY

Accordingly, embodiments of the present invention are directed toward an organic light emitting display capable of minimizing or reducing the amount of current that flows instantaneously when the display is driven in a concurrent emission method and a method of driving the same.

In order to achieve the foregoing and/or other aspects of the present invention, there is provided a method of driving an organic light emitting display in which a panel is divided into j blocks (j is a natural number no less than 2), the method including setting pixels included in the j blocks in a non-emission state, charging voltages at the pixels, the voltages corresponding to data signals, and emitting light by the pixels in units of horizontal lines respectively included in the j blocks in accordance with the voltages charged at the pixels.

The light may be emitted in an order of from the pixels positioned in first ones of the horizontal lines to the pixels positioned in last ones of the horizontal lines respectively included in the j blocks.

There is provided a method of driving an organic light emitting display, in which a panel is divided into j blocks (j is a natural number no less than 2) including a plurality of emission control lines and pixels each having a control transistor configured to be turned off when emission control signals are supplied to the emission control lines in order to control emission times of the pixels and configured to be turned on in other periods, the method including supplying emission control signals to the emission control lines included in the j blocks, selecting pixels in units of horizontal lines respectively included in the j blocks while sequentially supplying scan signals to scan lines, supplying data signals to the pixels selected by the scan signals, and sequentially stopping supply of the emission control signals in the j blocks.

The supply of the emission control signals may be stopped in an order of from first ones of the emission control lines respectively included in the j blocks to last ones of the emission control lines respectively included in the j blocks. The durations of the emission control signals supplied to the emission control lines included in the j blocks may be set to be the same.

There is provided an organic light emitting display including a scan driver for supplying scan signals to scan lines and for supplying emission control signals to emission control lines, a data driver for supplying data signals to data lines in synchronization with the scan signals, and a panel including pixels for storing voltages corresponding to the data signals when the scan signals are supplied and for controlling an amount of current supplied to an organic light emitting diode (OLED) included in each of the pixels when the emission control signals are not supplied. The panel is divided into j blocks (j is a natural number no less than 2) including a plurality of emission control lines, and the scan driver is configured to sequentially supply the emission control signals in the blocks. The scan driver may be configured to supply the emission control signals to all of emission control lines included in the j blocks in a period where all of the pixels included in the panel are charged with voltages corresponding to the data signals. The scan driver is configured to stop the supply of the emission control signals in an order of from first ones of the emission control lines respectively included in the j blocks to last ones of the emission control lines respectively included in the j blocks. The emission control signals supplied to the emission control lines included in the j blocks may be set to have the same duration.

Each of the pixels includes an OLED, a second transistor for controlling the amount of current supplied to the OLED, a storage capacitor coupled between a gate electrode of the second transistor and a first power source, and a third transistor coupled between a second electrode of the second transistor and the OLED, the third transistor being configured to be turned off when an emission control signal is supplied to an i^{th} emission control line (i is a natural number) and being configured to be turned on in other cases.

There is provided a method of driving an organic light emitting display, in which a panel is divided into j blocks (j is a natural number no less than 2) including a plurality of emission control lines and pixels each having a control transistor configured to be turned off when emission control signals are supplied to the emission control lines in order to control emission times of the pixels and configured to be turned on in other periods, the method including supplying the emission control signals to the emission control lines included in the j blocks, selecting pixels in units of horizontal lines respectively included in the j blocks while sequentially supplying scan signals to scan lines, supplying data signals to the pixels selected by the scan signals, and stopping supply of the emission control signals in the j blocks in units of k emission control lines (k is a natural number no less than 2) in each of the j blocks.

There is provided an organic light emitting display including a scan driver for supplying scan signals to scan lines and for supplying emission control signals to emission control lines, a data driver for supplying data signals to data lines in synchronization with the scan signals, and a panel including pixels for storing voltages corresponding to the data signals when the scan signals are supplied and for controlling an amount of current supplied to an organic light emitting diode (OLED) included in each of the pixels when the emission control signals are not supplied. The panel is divided into j blocks (j is a natural number no less than 2) including the emission control lines. The scan driver is configured to sequentially supply the emission control signals in each of the blocks in units of k emission control lines (k is a natural number no less than 2).

In the organic light emitting display according to the embodiments of the present invention and the method of driving the same, emission control signals are sequentially supplied by blocks so that it is possible to prevent or reduce high current from instantaneously flowing in the display.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a block diagram illustrating an organic light emitting display according to an embodiment of the present invention;

FIG. 2 is a view illustrating a panel divided into a plurality of blocks;

FIG. 3 is a view illustrating one frame according to an embodiment of the present invention;

FIG. 4 is a circuit diagram illustrating an embodiment of a pixel of FIG. 1;

FIG. 5 is a waveform diagram illustrating a method of driving the pixel of FIG. 4;

FIG. 6 is a circuit diagram illustrating another embodiment of the pixel of FIG. 1;

FIG. 7 is a view illustrating a frame according to another embodiment of the present invention; and

FIG. 8 is a waveform diagram illustrating a driving method according to another embodiment of the present invention.

### DETAILED DESCRIPTION OF THE EMBODIMENTS

Hereinafter, certain exemplary embodiments according to the present invention will be described with reference to the accompanying drawings. Here, when a first element is described as being coupled to a second element, the first element may be directly coupled to the second element or may be indirectly coupled to the second element via one or more third elements. Further, some of the elements that are not essential to a complete understanding of the invention are omitted for clarity. Also, like reference numerals refer to like elements throughout.

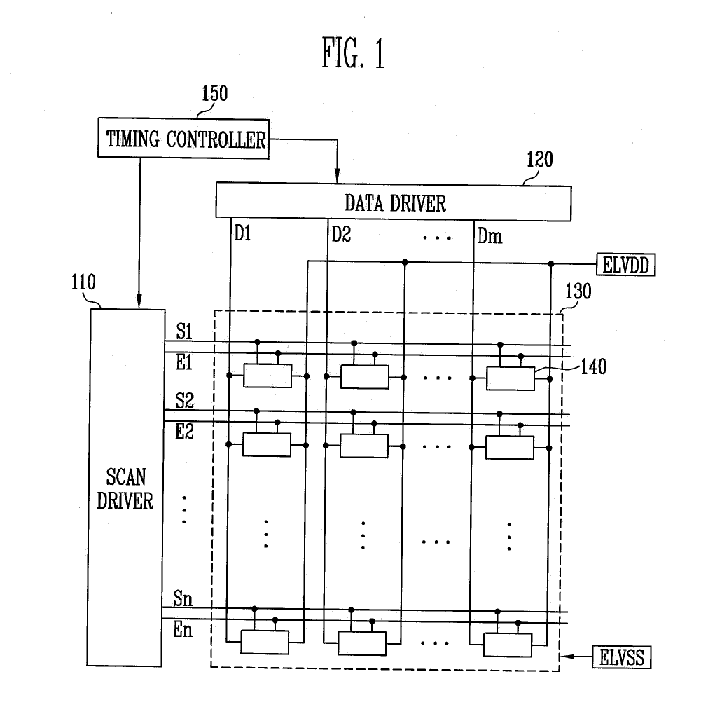

Hereinafter, the present invention will be described in detail with reference to FIGS. 1 to 8 accompanied by exemplary embodiments by which those skilled in the art may practice the present invention.

FIG. 1 is a block diagram illustrating an organic light emitting display according to an embodiment of the present invention.

Referring to FIG. 1, the organic light emitting display according to an embodiment of the present invention includes a display unit 130 including pixels 140 positioned at the crossing regions of scan lines S1 to Sn, emission control lines E1 to En, and data lines D1 to Dm, a scan driver 110 for driving the scan lines S1 to Sn and the emission control lines E1 to En, a data driver 120 for driving the data lines D1 to Dm, and a timing controller 150 for controlling the scan driver 110 and the data driver 120.

The scan driver 110 sequentially supplies scan signals to the scan lines S1 to Sn in a scan period of one frame. In addition, the scan driver 110 supplies emission control signals to the emission control lines E1 to En in the scan period of one frame. The scan driver 110 does not supply the emission control signals to the emission control lines E1 to En in an emission period of one frame. Here, the panel is conceptually divided into j blocks (j is a natural number no less than 2) including the plurality of emission control lines E. The points in time of supplying the emission control signals are controlled in blocks.

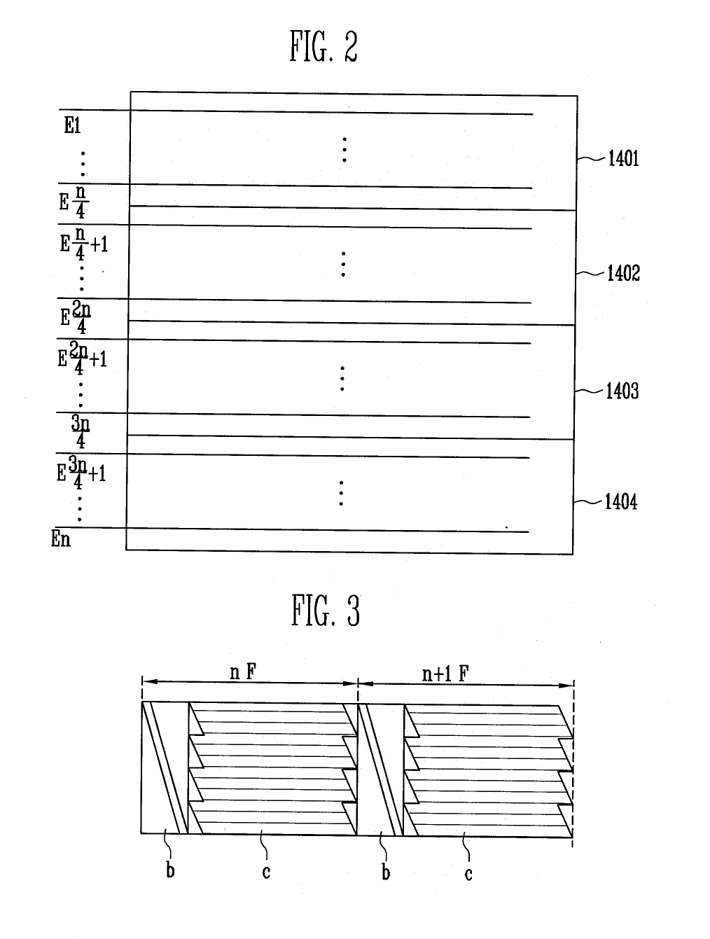

For example, the panel may be divided into four blocks as illustrated in FIG. 2. A first block 1401 includes a first emission control line E1 to a (n/4)^{th} emission control line En/4. A second block 1402 includes a (n/4+1)^{th} emission control line En/4+1 to a (2n/4)^{th} emission control line E2n/4. A third block 1403 includes a (2n/4+1)^{th} emission control line E2n/4+1 to a (3n/4)^{th} emission control line E3n/4. A fourth block 1404 includes a (3n/4+1)^{th} emission control line E3n/4+1 to an n^{th} emission control line En.

Here, the scan driver 110 sequentially supplies emission control signals from blocks 1401 to 1404. For example, the scan driver 110 sequentially supplies the emission control signals from the first emission control lines E1, En/4+1, E2n/4+1, and E3n/4+1 to the last emission control lines En/4, E2n/4, E3n/4, and En included in the blocks 1401 to 1404 in a scan period. On the other hand, since the durations of the emission control signals supplied to the emission control lines E1 to En are set to be equal, the supply of the emission control signals is stopped in the order of the first emission control lines E1, En/4+1, E2n/4+1, and E3n/4+1 to the last emission control lines En/4, E2n/4, E3n/4, and En included in each of the blocks 1401 to 1404.

The data driver 120 supplies data signals to the data lines D1 to Dm in synchronization with the scan signals supplied to the scan lines S1 to Sn in a scan period.

The timing controller 150 controls the scan driver 110 and the data driver 120.

The display unit 130 includes the pixels 140 positioned at the crossing regions of the scan lines S1 to Sn and the data lines D1 to Dm. The pixels 140 receive power from a first power source ELVDD and a second power source ELVSS. The pixels 140 control the amount of current supplied from the first power source ELVDD to the second power source ELVSS via an organic light emitting diode (OLED) to correspond to the data signals in the emission period of one frame.

FIG. 3 is a view illustrating one frame according to an embodiment of the present invention.

Referring to FIG. 3, the organic light emitting display according to the embodiment of the present invention is driven by the concurrent emission method. In the concurrent emission method according to the present invention, one frame is divided into a scanning period (b) and an emission period (c).

In the scanning period (b), the scan signals are sequentially supplied to the scan lines S1 to Sn and the data signals are supplied to the data lines D1 to Dm in synchronization with the scan signals. At this time, the pixels 140 are set to be in a non-emission state.

In the emission period (c), the pixels 140 emit light to correspond to the data signals. Here, the pixels 140 sequentially emit light in units of horizontal lines respectively in the blocks 1401 to 1404. When the pixels 140 sequentially emit light in units of horizontal lines respectively included in the blocks 1401 to 1404 in the emission period, it is possible to prevent or reduce high current from instantaneously flowing through the panel.

On the other hand, in FIG. 3, for convenience sake, it is illustrated that one frame is divided into the scanning period (b) and the emission period (c). However, the present invention is limited to the above. In some embodiments, the present invention may be applied to all of the organic light emitting displays driven by the concurrent emission method including the emission period.

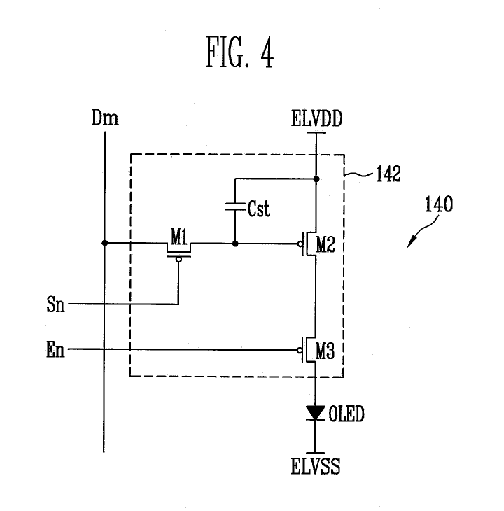

FIG. 4 is a circuit diagram illustrating an embodiment of the pixel of FIG. 1.

Referring to FIG. 4, the pixel 140 according to the embodiment of the present invention includes an OLED and a pixel circuit 142 for controlling the amount of current supplied to the OLED.

The anode electrode of the OLED is coupled to the pixel circuit 142, and the cathode electrode of the OLED is coupled to the second power source ELVSS. The OLED generates light with brightness (e.g., predetermined brightness) to correspond to the current supplied from the pixel circuit 142.

The pixel circuit 142 is charged with the voltage corresponding to the data signal and controls the amount of current supplied to the OLED to correspond to the charged voltage. According to embodiments of the present invention, the pixel circuit 142 may be realized by various types of suitable circuits in which the emission time is controlled by the emission control signal supplied from the emission control line En. In FIG. 4, the pixel circuit 142 includes three transistors M1 to M3 and a storage capacitor Cst.

The first electrode of the first transistor M1 is coupled to the data line Dm, and the second electrode of the first transistor M1 is coupled to the gate electrode of the second transistor M2. The gate electrode of the first transistor M1 is coupled to the scan line Sn. The first transistor M1 is turned on when a scan signal is supplied to the scan line Sn to electrically couple the data line Dm and the gate electrode of the second transistor M2 to each other.

The first electrode of the second transistor M2 (the driving transistor) is coupled to the first power source ELVDD, and the second electrode of the second transistor M2 is coupled to the first electrode of the third transistor M3. The gate electrode of the second transistor M2 is coupled to the second electrode of the first transistor M1. The second transistor M2 controls the amount of current supplied from the first power source ELVDD to the second power source ELVSS via the OLED to correspond to the voltage applied to the gate electrode of the second transistor M2.

The first electrode of the third transistor M3 is coupled to the second electrode of the second transistor M2, and the second electrode of the third transistor M3 is coupled to the anode electrode of the OLED. The gate electrode of the third transistor M3 is coupled to the emission control line En. The third transistor M3 is turned off when an emission control signal is supplied to the emission control line En and is turned on when the emission control signal is not supplied.

The storage capacitor Cst is coupled between the gate electrode of the second transistor M2 and the first power source ELVDD. The storage capacitor Cst stores the voltage corresponding to the data signal.

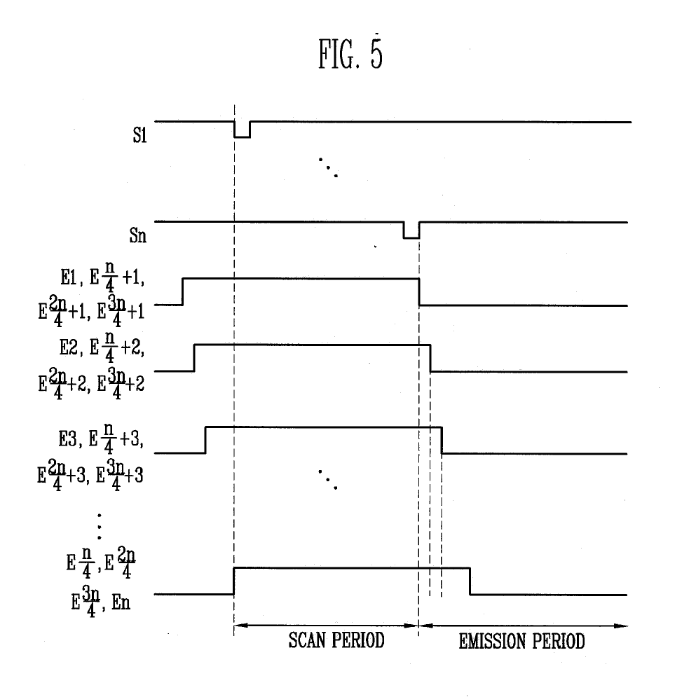

FIG. 5 is a waveform diagram illustrating a method of driving the pixel of FIG. 4. In FIG. 5, for convenience sake, as illustrated in FIG. 2, it is assumed that a panel is divided into four blocks.

Referring to FIG. 5, first, in the scan period, scan signals are sequentially supplied to the scan lines S1 to Sn, and data signals are supplied to the data lines D1 to Dm in synchronization with the scan signals. When a scan signal is supplied to the scan line Sn, the first transistor M1 is turned on. When the first transistor M1 is turned on, the data signal from the data line Dm is supplied to the gate electrode of the second transistor M2. At this time, the storage capacitor Cst charges the voltage corresponding to the data signal.

On the other hand, in the scan period, emission control signals are supplied to the emission control lines E1 to En so that the third transistor M3 included in each of the pixels 140 is set in a turn off state. In this case, current is not supplied to the OLED so that the pixels 140 are set in a non-emission state.

In the emission period, the supply of the emission control signals is sequentially stopped in units of the blocks 1401 to 1404. That is, the supply of the emission control signals is sequentially stopped from the first emission control lines E1, En/4+1, E2n/4+1, and E3n/4+1 respectively included in the blocks 1401 to 1404 to the last emission control lines En/4, E2n/4, E3n/4, and En respectively included in the blocks 1401 to 1404.

When the supply of the emission control signals to the first emission control lines E1, En/4+1, E2n/4+1, and E3n/4+1 is stopped, the third transistor M3 included in each of the pixels 140 coupled to the first emission control lines E1, En/4+1, E2n/4+1, and E3n/4+1 is turned on. Then, the pixels 140 coupled to the first emission control lines E1, En/4+1, E2n/4+1, and E3n/4+1 emit light.

When the supply of the emission control signals to the last emission control lines En/4, E2n/4, E3n/4, and En is stopped, the third transistor M3 included in each of the pixels 140 coupled to the last emission control lines En/4, E2n/4, E3n/4, and En is turned on. Then, the pixels 140 coupled to the last emission control lines En/4, E2n/4, E3n/4, and En emit light.

Here, the pixels 140 sequentially emit light from the pixels 140 coupled to the first emission control lines E1, En/4+1, E2n/4+1, and E3n/4+1 to the pixels 140 coupled to the last emission control lines En/4, E2n/4, E3n/4, and En of the blocks 1401 to 1404 in the emission period. When the pixels 140 sequentially emit light in units of horizontal lines respectively in the blocks 1401 to 1404, the amount of current that flows through the panel may be minimized or reduced during the emission of the pixels 140.

In the emission period, all of the pixels 140 emit light in a period (e.g., a predetermined period) to correspond to the data signals. Then, the emission control signals are supplied to the first emission control lines E1, En/4+1, E2n/4+1, and E3n/4+1 to the last emission control lines En/4, E2n/4, E3n/4, and En of the blocks 1401 to 1404 in the stated order. Then, the pixels 140 are sequentially set in a non-emission state in units of horizontal lines respectively in the blocks 1401 to 1404. The above-described scan period and emission period are repeated to display an image by the pixels 140.

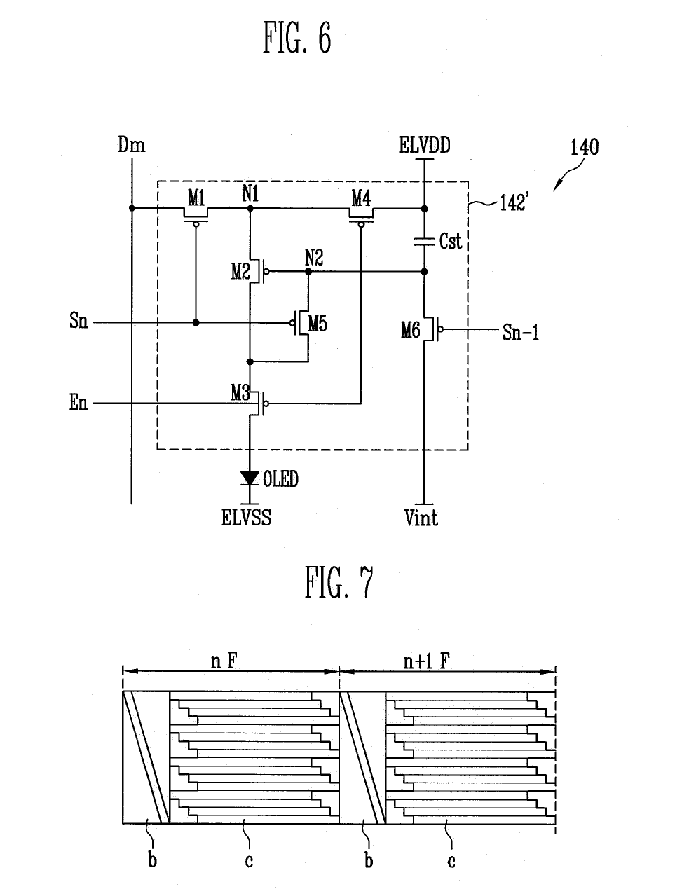

FIG. 6 is a circuit diagram illustrating another embodiment of the pixel of FIG. 1. In FIG. 6, transistors are added so that the threshold voltage of a driving transistor is compensated for, and the driving method is substantially the same as the pixel of FIG. 4.

Referring to FIG. 6, the pixel 140 according to an embodiment of the present invention includes an OLED and a pixel circuit 142′ for controlling the amount of current supplied to the OLED.

The anode electrode of the OLED is coupled to the pixel circuit 142′, and the cathode electrode of the OLED is coupled to the second power source ELVSS. The OLED generates light with brightness (e.g., predetermined brightness) to correspond to the current supplied from the pixel circuit 142′.

The pixel circuit 142′ is charged with the voltage corresponding to the data signal and the threshold voltage of the second transistor M2 and controls the amount of current supplied to the OLED to correspond to the charged voltage. In FIG. 6, the pixel circuit 142′ includes six transistors M1 to M6 and the storage capacitor Cst.

The first electrode of the first transistor M1 is coupled to the data line Dm, and the second electrode of the first transistor M1 is coupled to a first node N1. The gate electrode of the first transistor M1 is coupled to the n^{th} scan line Sn. The first transistor M1 is turned on when the scan signal is supplied to the n^{th} scan line Sn to supply the data signal supplied from the data line Dm to the first node N1.

The first electrode of the second transistor M2 is coupled to the first node N1, and the second electrode of the second transistor M2 is coupled to the first electrode of the third transistor M3. The gate electrode of the second transistor M2 is coupled to one terminal, which is coupled to a second node N2, of the storage capacitor Cst. The second transistor M2 supplies the current corresponding to the voltage charged in the storage capacitor Cst to the OLED.

The first electrode of the fifth transistor M5 is coupled to the second electrode of the third transistor M3, and the second electrode of the fifth transistor M5 is coupled to the second node N2. The gate electrode of the fifth transistor M5 is coupled to the n^{th} scan line Sn. The fifth transistor M5 is turned on when the scan signal is supplied to the n^{th} scan line Sn to couple (or diode-connect) the second transistor M2 in the form of a diode.

The first electrode of the sixth transistor M6 is coupled to the second node N2, and the second electrode of the sixth transistor M6 is coupled to an initial power source Vint. The gate electrode of the sixth transistor M6 is coupled to an (n−1)^{th} scan line Sn−1. The sixth transistor M6 is turned on when a scan signal is supplied to the (n−1)^{th} scan line Sn−1 to supply the voltage of the initial power source Vint to the second node N2. Here, the initial power source Vint is set as a voltage lower than that of the data signal.

The first electrode of the third transistor M3 is coupled to the second electrode of the second transistor M2, and the second electrode of the third transistor M3 is coupled to the anode electrode of the OLED. The gate electrode of the third transistor M3 is coupled to the emission control line En. The third transistor M3 is turned off when an emission control signal is supplied to the emission control line En and is turned on when the emission control signal is not supplied. When the third transistor M3 is turned on, the OLED and the second transistor M2 are electrically coupled to each other.

The first electrode of the fourth transistor M4 is coupled to the first power source ELVDD, and the second electrode of the fourth transistor M4 is coupled to the first node N1. Here, the gate electrode of the fourth transistor M4 is coupled to the emission control line En. The fourth transistor M4 is turned off when the emission control signal is supplied to the emission control line En and is turned on when the emission control signal is not supplied. When the fourth transistor M4 is turned on, the first power source ELVDD and the first node N1 are electrically coupled to each other.

The storage capacitor Cst is coupled between the second node N2 and the first power source ELVDD. The storage capacitor Cst stores the voltage corresponding to the data signal and the threshold voltage of the second transistor M2.

The operation processes are described with reference to FIGS. 5 and 6. First, in the scan period, the scan signals are sequentially supplied to the scan lines S0 to Sn and the data signals are supplied to the data lines D1 to Dm in synchronization with the scan signals.

When a scan signal is supplied to the (n−1)^{th} scan line Sn−1, the sixth transistor M6 is turned on. When the sixth transistor M6 is turned on, the voltage of the initial power source Vint is supplied to the second node N2.

Then, the scan signal is supplied to the n^{th} scan line Sn so that the first transistor M1 and the fifth transistor M5 are turned on. When the first transistor M1 is turned on, the data signal from the data line Dm is supplied to the first node N1. When the fifth transistor M5 is turned on, the second transistor M2 is coupled (or diode-connected) in the form of a diode. At this time, since the second node N2 is initialized by the voltage of the initial power source Vint, the second transistor M2 is turned on.

When the second transistor M2 is turned on, the voltage value obtained by subtracting the threshold voltage of the second transistor M2 from the voltage of the data signal is applied to the second node N2. At this time, the storage capacitor Cst stores the voltage corresponding to the data signal and the threshold voltage of the second transistor M2.

On the other hand, in the scan period, the emission control signals are supplied to the emission control lines E1 to En so that the third transistor M3 included in each of the pixels 140 is set in a turn off state. In this case, current is not supplied to the OLED so that the pixels 140 are set in a non-emission state.

In the emission period, the supply of the emission control signals is sequentially stopped in units of the blocks 1401 to 1404. That is, the supply of the emission control signals is sequentially stopped from the first emission control lines E1, En/4+1, E2n/4+1, and E3n/4+1 to the last emission control lines En/4, E2n/4, E3n/4, and En respectively included in the blocks 1401 to 1404.

In this case, in the emission period, light is emitted in the order of the pixels 140 coupled to the first emission control lines E1, En/4+1, E2n/4+1, and E3n/4+1 to the pixels 140 coupled to the last emission control lines En/4, E2n/4, E3n/4, and En respectively included in the blocks 1401 to 1404. When the pixels 140 sequentially emit light in units of horizontal lines respectively in the blocks 1401 to 1404, the amount of current that flows to the panel is minimized or reduced during the emission of the pixels 140.

In the emission period, all of the pixels 140 emit light in a period (e.g., a predetermined period) to correspond to the data signals. Then, the emission control signals are supplied in the order of the first emission control lines E1, En/4+1, E2n/4+1, and E3n/4+1 to the last emission control lines En/4, E2n/4, E3n/4, and En respectively included in the blocks 1401 to 1404. Then, the pixels 140 are sequentially set in a non-emission state in units of horizontal lines respectively in the blocks 1401 to 1404. Then, the above-described scan period and emission period are repeated so that the pixels 140 display a predetermined image.

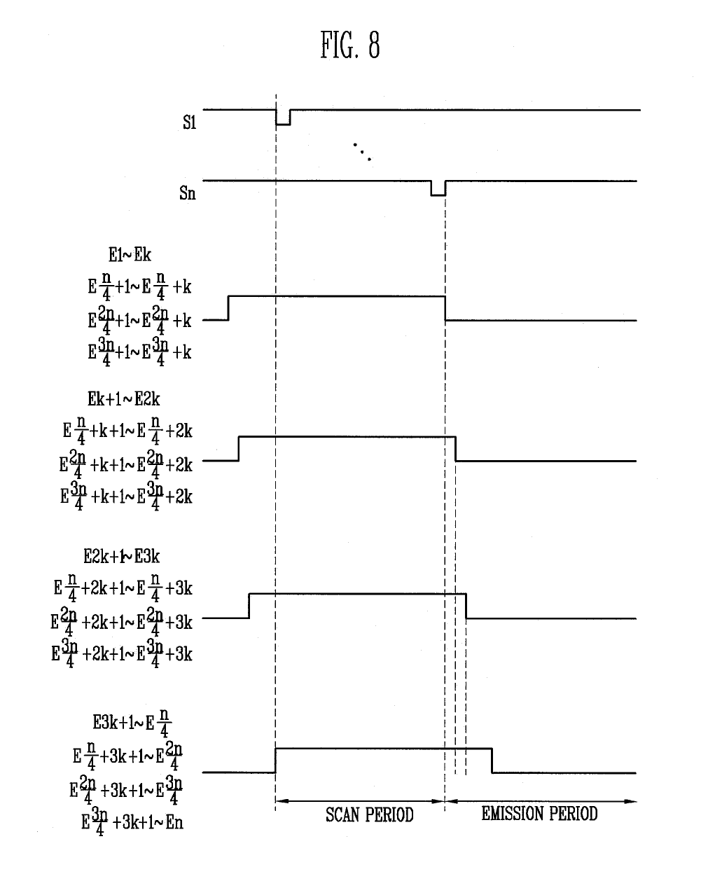

FIG. 7 is a view illustrating a frame according to another embodiment of the present invention. FIG. 8 is a waveform diagram illustrating a driving method according to another embodiment of the present invention. In describing FIGS. 7 and 8, description of the same elements as those of FIG. 3 will be omitted.

Referring to FIGS. 7 and 8, the driving period of an organic light emitting display according to another embodiment of the present invention is divided into a scanning period (b) and an emission period (c).

In the scanning period (b), the scan signals are sequentially supplied to the scan lines S1 to Sn and the data signals are supplied to the data lines D1 to Dm in synchronization with the scan signals. At this time, the pixels 140 store the voltages corresponding to the data signals. In the scan period, the pixels 140 are set in the non-emission state.

In the emission period (c), the pixels 140 emit light to correspond to the data signals. Here, the pixels 140 sequentially emit light in units of k emission control lines (k is a natural number no less than 2). That is, according to another embodiment of the present invention, the emission control signals are sequentially supplied in units of the k emission control lines respectively in the blocks 1401 to 1404 so that it is possible to prevent or reduce high current from instantaneously flowing through the panel. In addition, when the emission control signals are supplied in units of k emission control lines respectively in the blocks 1401 to 1404, waveforms are simplified and the emission times of the pixels 140 may be secured.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method of driving an organic light emitting display in which a panel is divided into j blocks (j is a natural number no less than 2), the method comprising:
setting pixels included in the j blocks in a non-emission state;
charging voltages at the pixels, the voltages corresponding to data signals; and
emitting light by the pixels in units of horizontal lines respectively included in the j blocks in accordance with the voltages charged at the pixels.

2. The method as claimed in claim 1, wherein the light is emitted in an order of from the pixels positioned in first ones of the horizontal lines to the pixels positioned in last ones of the horizontal lines respectively included in the j blocks.

3. A method of driving an organic light emitting display, in which a panel is divided into j blocks (j is a natural number no less than 2) including a plurality of emission control lines and pixels each having a control transistor configured to be turned off when emission control signals are supplied to the emission control lines in order to control emission times of the pixels and configured to be turned on in other periods, the method comprising:
supplying emission control signals to the emission control lines included in the j blocks;
selecting pixels in units of horizontal lines respectively included in the j blocks while sequentially supplying scan signals to scan lines;
supplying data signals to the pixels selected by the scan signals; and
sequentially stopping supply of the emission control signals in the j blocks.

4. The method as claimed in claim 3, wherein the supply of the emission control signals is stopped in an order of from first ones of the emission control lines respectively included in the j blocks to last ones of the emission control lines respectively included in the j blocks.

5. The method as claimed in claim 4, wherein durations of the emission control signals supplied to the emission control lines included in the j blocks are set to be the same.

6. An organic light emitting display comprising:
a scan driver for supplying scan signals to scan lines and for supplying emission control signals to emission control lines;
a data driver for supplying data signals to data lines in synchronization with the scan signals; and
a panel comprising pixels for storing voltages corresponding to the data signals when the scan signals are supplied and for controlling an amount of current supplied to an organic light emitting diode (OLED) included in each of the pixels when the emission control signals are not supplied,
wherein the panel is divided into j blocks (j is a natural number no less than 2) including a plurality of emission control lines, and
wherein the scan driver is configured to sequentially supply the emission control signals in the blocks.

7. The organic light emitting display as claimed in claim 6, wherein the scan driver is configured to supply the emission control signals to all of emission control lines included in the j blocks in a period where all of the pixels included in the panel are charged with voltages corresponding to the data signals.

8. The organic light emitting display as claimed in claim 6, wherein the scan driver is configured to stop the supply of the emission control signals in an order of from first ones of the emission control lines respectively included in the j blocks to last ones of the emission control lines respectively included in the j blocks.

9. The organic light emitting display as claimed in claim 8, wherein the emission control signals supplied to the emission control lines included in the j blocks are set to have the same duration.

10. The organic light emitting display as claimed in claim 6, wherein each of the pixels comprises:
an OLED;
a second transistor for controlling the amount of current supplied to the OLED;
a storage capacitor coupled between a gate electrode of the second transistor and a first power source; and
a third transistor coupled between a second electrode of the second transistor and the OLED, the third transistor being configured to be turned off when an emission control signal is supplied to an i^{th} emission control line (i is a natural number) and being configured to be turned on in other cases.

11. The organic light emitting display as claimed in claim 10, wherein each of the pixels further comprises a first transistor coupled between the gate electrode of the second transistor and a data line, the first transistor being configured to be turned on when a scan signal is supplied to an i^{th} scan line.

12. The organic light emitting display as claimed in claim 10, wherein each of the pixels further comprises:
a first transistor coupled between a first electrode of the second transistor and a data line, the first transistor being configured to be turned on when a scan signal is supplied to an i^{th} scan line;
a fourth transistor coupled between the first electrode of the second transistor and the first power source, the fourth transistor being configured to be turned off when an emission control signal is supplied to an i^{th} emission control line;
a fifth transistor coupled between the gate electrode of the second transistor and the second electrode of the second transistor, the fifth transistor being configured to be turned on when the scan signal is supplied to the i^{th} scan line; and
a sixth transistor coupled between the gate electrode of the second transistor and an initial power source, the sixth transistor configured to be turned on when a scan signal is supplied to an (i−1)^{th} scan line.

13. The organic light emitting display as claimed in claim 12, wherein the initial power source is set as a voltage lower than that of the data signals.

14. A method of driving an organic light emitting display, in which a panel is divided into j blocks (j is a natural number no less than 2) including a plurality of emission control lines and pixels each having a control transistor configured to be turned off when emission control signals are supplied to the emission control lines in order to control emission times of the pixels and configured to be turned on in other periods, the method comprising:
supplying the emission control signals to the emission control lines included in the j blocks;
selecting pixels in units of horizontal lines respectively included in the j blocks while sequentially supplying scan signals to scan lines;
supplying data signals to the pixels selected by the scan signals; and
stopping supply of the emission control signals in the j blocks in units of k emission control lines (k is a natural number no less than 2) in each of the j blocks.

15. The method as claimed in claim 14, wherein the durations of the emission control signals supplied to the emission control lines included in the j blocks are the same.

16. An organic light emitting display comprising:
a scan driver for supplying scan signals to scan lines and for supplying emission control signals to emission control lines;
a data driver for supplying data signals to data lines in synchronization with the scan signals; and
a panel comprising pixels for storing voltages corresponding to the data signals when the scan signals are supplied and for controlling an amount of current supplied to an organic light emitting diode (OLED) included in each of the pixels when the emission control signals are not supplied,
wherein the panel is divided into j blocks (j is a natural number no less than 2) including the emission control lines, and
wherein the scan driver is configured to sequentially supply the emission control signals in each of the blocks in units of k emission control lines (k is a natural number no less than 2).

17. The organic light emitting display as claimed in claim 16, wherein the scan driver is configured to supply the emission control signals to all of the emission control lines included in the j blocks in a period where all of the pixels included in the panel are being charged with voltages corresponding to the data signals.

18. The organic light emitting display as claimed in claim 16, wherein the durations of the emission control signals supplied to the emission control lines included in the j blocks are the same.
